(19) United States
(12) Patent Application Publication
(10) Pub. No.: US 2014/0282058 A1
(43) Pub. Date: Sep. 18, 2014

(54) ELECTRONIC DEVICE WITH A FUNICTION OF APPLYING APPLICATIONS OF DIFFERENT OPERATING SYSTEMS, SYSTEM AND METHOD THEREOF

(71) Applicant: POWER-ALL NETWORKS LIMITED, Shatin (HK)

(72) Inventor: STEVE LAP WAI HUI, Shatin (HK)

(73) Assignee: POWER-ALL NETWORKS LIMITED, Shatin (HK)

(21) Appl. No.: 14/205,390

(22) Filed: Mar. 12, 2014

(30) Foreign Application Priority Data
Mar. 15, 2013 (CN) 2013100833523

(51) Int. Cl. G06F 3/0487; G06F 3/0481; H04L 12/24; G06F 3/0484

(52) U.S. Cl. CPC G06F 3/0487; G06F 3/04842; G06F 3/04817; H04L 41/22
USPC 715/744

(57) ABSTRACT

A method for applying applications of different operating systems on one electronic device, the method includes, providing an icon interface on a display unit of the electronic device. Determining an icon selected by a user in response a manual operation. Determining an application corresponding to the selected icon and operating system supporting the application. Determining whether an operating system currently running in the electronic device is the same as the determined operating system. If no, determining whether one of the operating systems installed in the electronic device is the same as the determined operating system. If no, requesting a host server to trigger an operating system server running the operating system supporting the determined application to execute the application.

### CROSS REFERENCE TO RELATED APPLICATIONS

This application is related to the following co-pending, commonly assigned patent applications, the disclosures of which are incorporated herein by reference in their entirety:

1. “SYSTEM FOR APPLYING APPLICATIONS OF DIFFERENT OPERATING SYSTEMS IN ONE ELECTRONIC DEVICE AND METHOD THEREOF” by Steve Lap Wai Hui, whose Attorney Docket No is US51414.

2. “ELECTRONIC DEVICE WITH A FUNCTION OF APPLYING APPLICATIONS OF DIFFERENT OPERATING SYSTEMS AND METHOD THEREOF” by Steve Lap Wai Hui, whose Attorney Docket No is US51415.

3. “ELECTRONIC DEVICE WITH A FUNCTION OF APPLYING APPLICATIONS OF DIFFERENT OPERATING SYSTEMS AND METHOD THEREOF” by Steve Lap Wai Hui, whose Attorney Docket No is US51416.

4. “SYSTEM FOR UPDATING ICON INTERFACE WITH ICONS OF DIFFERENT OPERATING SYSTEMS AND METHOD THEREOF” by Steve Lap Wai Hui, whose Attorney Docket No is US51418.

### BACKGROUND

1. Technical Field

The present disclosure relates to system, and particularly to a system capable of applying a number of applications of different operating systems on one electronic device, and a system and an applying method.

2. Description of Related Art

Electronic devices, such as mobile phones and tablet computers, are more and more popular. Usually, the electronic device has a certain operating system installed, such as, a WINDOWS operating system, a LINUX operating system, an ANDROID operating system. However, the general electronic device is only capable of installing applications supported by the operating system installed in the electronic device, and applications which are not supported cannot be installed in the electronic device. For example, an ANDROID application only can be installed in the electronic device with the ANDROID operating system, and cannot be installed in the electronic device with the WINDOWS operating system. Therefore, if an application developer just develops an application for one operating system, the application can only be installed on one operating system.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of an electronic device with a function of applying a number of applications of different operating systems.

FIG. 2 is a schematic diagram of an embodiment of an icon interface.

FIG. 3 is a schematic diagram of another embodiment of an icon interface.

FIG. 4 is a flowchart diagram of an embodiment of a method for applying a number of applications of different operating systems on one electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the accompanying drawings.

FIG. 1 shows an embodiment of an electronic device 100 with a function of applying a number of applications of different operating systems. A number of operating systems are installed on the electronic device 100, such as, a LINUX operating system, a WINDOWS operating system, an ANDROID operating system, and a MAC operating system. The electronic device 100 can be a mobile phone, a tablet computer, a portable computer, or a desktop computer, for example.

As shown in FIG. 1, the electronic device 100 includes a display unit 10, a processing unit 20, a communication unit 30, and a storage unit 40. In the embodiment, the display unit 10 is a touch screen; in another embodiment, the display unit 201 can be a display screen and the display unit 10 may combine a keyboard or a touchpad to constitute an input/output device. The processing unit 20 can be a central processing unit, a digital processor, or a single chip, for example. The storage unit 40 can be a hard disk, a flash memory, or a compact disk, for example.

The processing unit 20 is used to run a system S1 for applying a number of applications of different operating systems on the electronic device 100. The system S1 includes an interface providing module 21, an operation detection module 22, an application determination module 23, an operating system determining module 24, and an execution controlling module 25. In the embodiment, the interface providing module 21, the operation detection module 22, the application determination module 23, the operating system determining module 24, and the execution controlling module 25 are collection of software instructions, and executed by the processing unit 20 of the electronic device 100.

FIG. 2 show that the interface providing module 21 is used to provide an icon interface TS and display the icon interface TS on the display unit 10. As shown in FIG. 2, the icon interface TS includes a number of icons TI, each of which corresponds to an application running in an operating system. For example, the icons TI include a browser icon TI1 applied in the LINUX operating system, a media player 1 icon TI2 applied in the ANDROID system. As shown in FIG. 2, the icons TI corresponding different operating systems are arranged in the icon interface TS randomly.

Referring to FIG. 3 together, in another embodiment, each operating system is assigned with a corresponding area on the display unit 10 for locating the icons TI thereof. For example, the icons TI belonging to the same operating system are located on the same row. Therefore, a user can operate and manage the icons TI of the same operating system conveniently.

In the embodiment, the interface providing module 21 provides the icon interface TS including the stored icons TI in an operating system after the electronic device 100 enters the operating system according to a selection by a user or by default.

The operation detection module 22 detects operations on the icon interface TI by the user and determines an icon TI selected by the user according to the operation of the user.

The application determination module 23 is used to determine an application corresponding to the selected icon TI and an operating system supporting the application. In the embodiment, the storage unit 40 stores relationship information of each icon TI. The relationship information includes identification information of an application and identification information of a corresponding operating system. The application determination module 23 determines the application according to the identification information of the application and determines the operating system supporting the application according to the identification information of the operating system.

The operating system determination module 24 determines whether the operating system currently running in the electronic device 100 is the same as the operating system determined by the application determination module 23. The operating system determines module 24 further determines whether one of the operating systems installed in the electronic device 100 is the same as the operating system determined by the application determination module 23, after determining the operating system currently running in the electronic device 100 is not the same as the operating system determined by the application determination module 23.

When the operating system determination module 24 determines the operating system currently running in the electronic device 100 is the same as the operating system determined by the application determination module 23, the execution controlling module 25 controls to execute the application corresponding to the icon TI directly. When the operating system determination module 24 determines the operating system currently running in the electronic device 100 is not the same as the operating system determined by the application determination module 23 and determines one of the operating systems installed in the electronic device 100 is the same as the operating system determined by the application determination module 23, the execution controlling module 25 switches the operating system of the electronic device to the determined operating system and controls to execute the application in the switched operating system.

For example, if the operating system currently running in the electronic device 100 is the LINUX operating system and the ANDROID operating system is installed on the electronic device 100, the application determination module 23 determines the application corresponding to the selected icon TI is a media player 1 (ANDROID) and the operating system supporting the application is the ANDROID operating system, then the execution controlling module 25 switches the operating system of the electronic device 100 to the ANDROID operating system, and then executes the application in the ANDROID operating system.

If the operating system determination module 24 determines none of the operating systems installed in the electronic device 100 is the same as the operating system determined by the application determination module 23, the execution controlling module 25 controls the communication unit 30 to connect to a host server 230 via a network, then requests the host server 230 to trigger an operating system server 300 running/installing the determined operating system to execute the application corresponding to the selected icon TI. In the embodiment, the host server 230 is connected to a number of operating system servers 300 via networks.

In detail, the execution controlling module 25 sends the identification information of the application and an execution request to the host server 230. The host server 230 determines the operating system server 300 running the operating system supporting the application according to the identification information of the application, and then controls the determined operating system server 300 to execute the application.

In the embodiment, the execution controlling module 25 also obtains an application interface of the operating system server 300, when the operating system server 300 executes the application corresponding to the selected icon TI. In the embodiment, the application interface of the operating system server 300 is produced when the operating system server 300 executes the application.

The interface providing module 21 also displays the application interface on the display unit 10 of the electronic device 100.

In the embodiment, the icons TI of the icon interface TS is updated after an application is installed into the electronic device 100 or is uninstalled from the electronic device 100. In detail, the interface providing module adds an icon TI to the icon interface TS after an application corresponding to the icon TI is installed into the electronic device 100, and deletes an icon TI from the icon interface TS after an application corresponding to the icon TI is uninstalled from the electronic device 100.

In the embodiment, the network among the electronic device 200, the host server 230, and the number of operating system servers 300 can be an internet, an on-demand virtual lease line, a wireless network including WIFI and BLUETOOTH, a telecommunication network including a GPRS network, a CDMA network, or a broadcasting network. The network between the electronic device 100 and the host server 230 and the network between the host server 230 and the number of operating system servers 300 can be the same or different. The networks can be public network or private network. The communication unit 30 can be a communication chip complying with the corresponding network.

FIG. 4 is a flowchart diagram illustrating a method for applying for applying a number of applications of different operating systems on one electronic device. At first, the interface providing module 21 provides the icon interface TS and displays the icon interface TS on the display unit 10 (S401). In the embodiment, the interface providing module 21 provides the icon interface TS in a certain operating system, such as the ANDROID operating system, after the electronic device 100 is started up completely and enters the operating system according to a selection of a user or by default.

The operation detection module 22 detects operations on the icon interface TI by a user and determines an icon TI selected by the user (S403).

The application determination module 23 determines an application corresponding to the selected icon TI and an operating system supporting the application (S405). In detail, the application determination module 23 determines the application according to the identification information of the application of the relationship information and determines the operating system supporting the application according to the identification information of the operating system of the relationship information.

The operating system determination module 24 determines whether the operating system currently running in the electronic device 100 is the same as the determined operating system (S407). If yes, the process jumps to S409, and if no, the process jumps to S411.

The execution controlling module 25 controls to execute the application corresponding icon TI directly (S409).

The operating system determines module determines whether one of the operating systems installed in the electronic device 100 is the same as the determined operating system (S411). If yes, the process jumps to S413, and if no, the process jumps to S415.

The execution controlling module 25 switches the operating system of the electronic device to the determined operating system and controls to executes the application in the switched operating system (S413).

The execution controlling module 25 controls the electronic device to connect to a host server 230 if none of the operating systems installed in the electronic device 100 is the same as the determined operating system (S415).

The execution controlling module 25 then requests the host server 230 to trigger an operating system server 300 running the operating system the same as the determined operating system to execute the application corresponding to the selected icon TI (S417). In detail, the execution controlling module 25 sends the identification information of the application and an execution request to the host server 230. The host server 230 determines the operating system server 300 running the operating system supporting the application according to the identification information of the application, and then controls the determined operating system server 300 to execute the application.

The method also includes a step as follows, the execution controlling module 25 obtains an application interface of the operating system server 300, when the operating system server 300 executes the application corresponding to the selected icon TI; and the interface providing module 21 displays the application interface on the display unit 10 of the electronic device 100.

According to the electronic device 100 and method of the present disclosure, the user can share/apply the applications of different operating systems by using the one electronic device 200.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device with a function of applying a plurality of applications of different operating systems, the electronic device installed a plurality of operating systems, the electronic device comprising:
a display unit; and
a processing unit comprising:
an interface providing module configured to provide an icon interface and display the icon interface on the display unit, wherein the icon interface comprises a plurality of icons corresponding to applications running in different operating systems;
an operation detection module configured to detect operations on the icon interface by the user and determine an icon selected by the user;
an application determination module configured to determine an application corresponding to the selected icon and an operating system supporting the application;
an operating system determination module configured to determine whether an operating system currently running in the electronic device is the same as the operating system determined by the application determination module; and to determine whether one of the operating systems installed in the electronic device is the same as the operating system determined by the application determination module after determining the operating system currently running in the electronic device is not the same as the operating system determined by the application determination module; and
an execution controlling module configured to execute the application corresponding icon directly when the operating system currently running in the electronic device is the same as the determined operating system, and switch the operating system of the electronic device to the determined operating system and control to execute the application in the switched operating system when the operating system currently running in the electronic device is not the same as the determined operating system and one of the operating systems installed in the electronic device is the same as the determined operating system; and request a host server to trigger an operating system server running the determined operating system to execute the application corresponding to the selected icon when none of the operating systems installed in the electronic device is the same as the determined operating system.

2. The electronic device according to claim 1, wherein the execution controlling module is further configured to obtain an application interface of the operating system server, when the operating system server executes the application corresponding to the selected icon; and the interface providing module is further configured to display the application interface on the display unit of the electronic device.

3. The electronic device according to claim 1, further comprising a storage unit storing relationship information of each icon, wherein the relationship information comprises identification information of an application and identification information of a corresponding operating system, the application determination module determines the application according to the identification information of the application and determines the operating system supporting the application according to the identification information of the operating system.

4. The electronic device according to claim 3, wherein the execution controlling module sends the identification information of the application and an execution request to the host server, and cause the host server to determine the operating system server running the operating system supporting the application according to the identification information of the application, and then control the determined operating system server to execute the application.

5. A system for applying a plurality of applications of different operating systems on an electronic device, the system applied in the electronic device with a display unit, the system comprising:
a plurality of modules which are collection of instructions executed by one or more processing units of the electronic device, the modules comprising:
an interface providing module configured to provide an icon interface and display the icon interface on the display unit, wherein the icon interface comprises a plurality of icons corresponding to applications running in different operating systems;
an operation detection module configured to detect operations on the icon interface by the user and determine an icon selected by the user;
an application determination module configured to determine an application corresponding to the selected icon and an operating system supporting the application;
an operating system determination module configured to determine whether an operating system currently running in the electronic device is the same as the operating system determined by the application determination module, and to determine whether one of the operating systems installed in the electronic device is the same as the operating system determined by the application determination module when determining the operating system currently running in the electronic device is not the same as the operating system determined by the application determination module; and
an execution controlling module configured to execute the application corresponding icon directly when the operating system currently running in the electronic device is the same as the determined operating system, and switch the operating system of the electronic device to the determined operating system and controls to execute the application in the switched operating system when the operating system currently running in the electronic device is not the same as the determined operating system and one of the operating systems installed in the electronic device is the same as the determined operating system; and request a host server to trigger an operating system server running the determined operating system to execute the application corresponding to the selected icon when none of the operating systems installed in the electronic device is the same as the determined operating system.

6. The system according to claim 5, wherein the execution controlling module is further configured to obtain an application interface of the operating system server, when the operating system server executes the application corresponding to the selected icon; and the interface providing module is further configured to display the application interface on the display unit of the electronic device.

7. The system according to claim 5, wherein each icon corresponds one relationship information, the relationship information comprises identification information of an application and identification information of a corresponding operating system, the application determination module determines the application according to the identification information of the application and determines the operating system supporting the application according to the identification information of the operating system.

8. The system according to claim 7, wherein the execution controlling module sends the identification information of the application and an execution request to the host server, and cause the host server to determine the operating system server running the operating system supporting the application according to the identification information of the application, and then control the determined operating system server to execute the application.

9. A method for applying a plurality of applications of different operating systems on one electronic device, comprising:
providing an icon interface and displaying the icon interface on a display unit of the electronic device;
detecting operations on the icon interface by a user and determining an icon selected by the user;
determining an application corresponding to the selected icon and an operating system supporting the application;
determining whether the operating system currently running in the electronic device is the same as the determined operating system;
controlling to execute the application corresponding icon directly if the operating system currently running in the electronic device is the same as the determined operating system;
determining whether one of the operating systems installed in the electronic device is the same as the determined operating system if the operating system currently running in the electronic device is not the same as the determined operating system;
switching the operating system of the electronic device to the determined operating system and controlling to execute the application in the switched operating system if one of the operating systems installed in the electronic device is the same as the determined operating system;
controlling the electronic device to connect to a host server if none of the operating systems installed in the electronic device is the same as the determined operating system; and
requesting the host server to trigger an operating system server running the operating system the same as the determined operating system to execute the application corresponding to the selected icon.

10. The method according to claim 9, wherein each icon corresponds to one relationship information, the relationship information comprises identification information of the application and identification information of the operating system supporting the application, the step of determining an application corresponding to the selected icon and an operating system supporting the application comprises:
determining the application according to the identification information of the application and determining the operating system supporting the application according to the identification information of the operating system.

11. The method according to claim 10, wherein the step of requesting a host server to trigger an operating system server running the operating system the same as the determined operating system to execute the application corresponding to the selected icon comprises:
sending the identification information of the application and an execution request to the host serve, and cause the host server to determine the operating system server running the operating system supporting the application according to the identification information of the application and to control the determined operating system server to execute the application.

12. The method according to claim 11, further comprising:
obtaining an application interface of the operating system server, when the operating system server executes the application corresponding to the selected icon; and
displaying the application interface on the display unit of the electronic device.
